(19) United States
(12) Patent Application Publication
(10) Pub. No.: US 2002/0106924 A1
(43) Pub. Date: Aug. 8, 2002

(54) Connector

(76) Inventor: Yasushi Uehara, Shinagawa-Ku (JP)

Correspondence Address: BAKER & BOTTS, 30 ROCKEFELLER PLAZA, NEW YORK, NY, 10112

(21) Appl. No.: 10/066,978

(22) Filed: Feb. 4, 2002

(30) Foreign Application Priority Data
Feb. 7, 2001 (JP) 2001-30,730

(51) Int. Cl. H01R 13/15

(52) U.S. Cl. 439/260

(57) ABSTRACT

A connector detachably fitted with a flexible printed circuit board or flexible flat cable includes contacts each having a contact portion to be brought into contact with the flexible printed circuit board or flexible flat cable, a block for holding and fixing the contacts therein, and a slider mounted on the block to be pivotally movable relative thereto. The slider is provided with urging portions for urging on being pivotally moved the flexible printed circuit board or flexible flat cable. The block or contacts are constructed so as to restrain the urging portions of the slider when the slider is urging the flexible printed circuit board or flexible flat cable, thereby preventing the urging portions of the slider from moving in a direction opposite to the urging direction. The connector according to the invention is capable of urging the flexible printed circuit board or flexible flat cable against the contact portions of the contacts with great certainty, thereby eliminating any defective electrical connection.

### BACKGROUND OF THE INVENTION

This invention relates to a connector for use in a portable or cellular telephone, CCD camera (charge-coupled device camera) and the like, and more particularly to a connector capable of firmly urging a flexible printed circuit board or flexible flat cable against contacts of the connector.

Connectors for use in portable telephones, CCD cameras or the like have been miniaturized and include contacts arranged with extremely narrow pitches. As shown in FIGS. 6A and 6B, one example of the connectors of the prior art mainly comprises a block 62, contacts 64 and a slider 66 to embrace a flexible printed circuit board (referred to herein as “FPC”) or a flexible flat cable (referred to herein as “FFC”) between the block 62 and the slider 66. Many features for embracing FPC or FFC between the block and the slider are envisioned.

The block 62 is formed with a required number of insertion apertures into which the contacts 64 are inserted and is further formed at the longitudinal ends with bearing portions 26 for supporting shafts 24 of the slider 66.

The contacts 64 are each in the form of a substantially U-shape and each comprise a contact portion 20 adapted to contact a flexible printed circuit board or flexible flat cable, a connection portion 36 to be connected to a board or the like, a fixing portion to be fixed to the block 62, and a guide portion 18 for guiding the pivotal movement of the slider 66. The contacts 64 are fixed to the block 62 by press-fitting or the like.

The slider 66 is, for example, substantially in the form of a crank as shown in FIGS. 6A and 6B and pivotally supported with its shafts 24 in the block 62 having the required number of the contacts 64 planted therein. Such a slider 66 mainly comprises shafts 24 supported in the bearing portions 26 of the block 62, an urging portion 68 for urging a flexible printed circuit board or flexible flat cable against the contact portions 20 of the contacts 64, and notched portions to be guided by the guide portions 18 of the contacts 64.

As shown in FIG. 7A, the slider 66 assumes substantially in a vertical position before the flexible printed circuit board or flexible flat cable is inserted into the connector. Upon inserting the flexible printed circuit board or flexible flat cable, the slider 66 is pivotally moved with its notched portions being guided by the guide portions 18 of the contacts 64 into a position substantially in parallel with the block 62 as shown in FIG. 7B.

With the electrical connector 60 thus constructed, when a flexible printed circuit board or flexible flat cable is being inserted between the guide portions 18 and contact portions 20 of the contacts 64 while the slider 66 is being pivotally moved as shown in FIGS. 7A and 7B, the slider 66 would exhibit a great resistance to the insertion of the board or cable. A problem which must be solved arises with such a resistance causing the slider 66 to expand at its mid portion in the direction shown by an arrow “C” in FIG. 8A, which makes it impossible to urge the flexible printed circuit board or flexible flat cable against the contact portions 20 of the contacts 64, giving rise to defective electrical connection.

### SUMMARY OF THE INVENTION

It is an object of the invention to provide an improved connector which eliminates all the disadvantages of the prior art and is capable of firmly urging a flexible printed circuit board or flexible flat cable against contact portions of the contacts without causing any defective electrical connection.

In order to accomplish this object, in an connector detachably fitted with a flexible printed circuit board or flexible flat cable, said connector including contacts each having a contact portion to be brought into contact with said flexible printed circuit board or flexible flat cable, a block for holding and fixing said contacts therein, and a slider mounted on said block to be pivotally movable relative thereto, according to the invention said slider is provided with urging portions for urging on being pivotally moved the flexible printed circuit board or flexible flat cable, and said block or contacts are constructed so as to restrain said urging portions of the slider when the slider is urging the flexible printed circuit board or flexible flat cable, thereby preventing said urging portions of the slider from moving in a direction opposite to the urging direction.

In a preferred embodiment of the invention, the slider is provided with fitting grooves in the proximity of the urging portions of the slider, and the contacts are each in the form of a substantially U-shape and provided on the side opposite to the contact portion with a fitting portion which is fitted in the fitting groove of the slider. With this arrangement, it is more ensured that the flexible printed circuit board or flexible flat cable is urged against the contact portions of the contacts.

Preferably, the urging portions of the slider have a cross-section whose extending distances from the center of pivotal movement of the slider in the urging direction vary before and after the pivotal movement, so that the extending distance after the pivotal movement is larger than before. In this manner, only pivotally moving the slider enables the flexible printed circuit board or flexible flat cable to be urged against the contact portions of the contacts because the urging portions of the slider are rotated between the contact portions and fitting portions of the contacts.

In a preferred embodiment, the urging portions of the slider have an elliptical cross-section. With this construction, the extending distances from the center of pivotal movement of the slider in the urging direction can be varied such that the extending distance after the pivotal movement can be larger than before.

In a further preferred embodiment, the fitting portion of each of the contacts is provided with a recess which engages the urging portion of the slider when it is urging the flexible printed circuit board or flexible flat cable. The engagement of the urging portions in the recesses of the contacts ensures that upon rotating the slider its urging portions are rotated between the contact portions and fitting portions of the contacts to urge the flexible printed circuit board or flexible flat cable against the contact portions.

Preferably, the contacts and further contacts are alternately arranged so that connection portions of the further contacts extend in directions opposite to the extending directions of connection portions of the contacts. Such an arrangement of the contacts achieves the extremely narrow pitches between the contacts.

Preferably, the block is provided with projections to be fitted in fitting grooves formed in the slider. Fitting the projections in the fitting grooves in the slider ensures that the flexible printed circuit board or flexible flat cable is urged against the contact portions of the contacts.

According to the invention, when the slider is pivotally moved in the urging direction, the urging portions of the slider are rotated between the contact portions and fitting portions of the contacts, and the variable or inconstant radii in cross-section such as major and minor axes of an elliptical cross-section of the urging portions of the slider enable the flexible printed circuit board or flexible flat cable to be urged against the contact portions of the contacts.

The connector according to the invention has the following significant functions and effects.

(1) According to the invention, when the slider is pivotally moved, the urging portions of the slider are rotated between the contact portions and fitting portions of the contacts, and the variable or inconstant radius of rotation in cross-section of the urging portions such as major and minor axes of an elliptical cross-section enable a flexible printed circuit board or flexible flat cable to be urged against the contact portions of the contact with the extending distance of the urging portion in the urging direction after rotated larger than before.

(2) According to the invention, the slider is provided with the urging portions which, when urging a flexible printed circuit board or flexible flat cable, are adapted to be restrained from moving in the direction opposite to the urging direction by means of the block or contacts for facilitating to bring the board or cable into contact with the contact portions of the contacts without any defective electrical connection.

(3) According to the invention, the slider is provided in the proximity of the urging portions with the receiving grooves, and the contacts are in the form of a substantially U-shape and are each provided on the side opposite to the contact portion with the fitting portion adapted to be fitted in one of the receiving grooves, thereby ensuring the urging of the flexible printed circuit board against the contact portions of the contacts without any unintentional movement of the slider in a direction opposite to the urging direction.

(4) The extending distances of the urging portions of the slider from the center of pivotal movement of the slider vary before and after the pivotal movement such that the extending distance after the pivotal movement is greater than before according to the invention. Only the pivotal movement of the slider causes the urging portions to rotate between the contact portions and fitting portions of the contacts so as to urge the flexible printed circuit board or flexible flat cable against the contact portions of the contacts without any defective electrical connection.

(5) According to the invention, the fitting portion of each the contact is formed with the recess adapted to engage the urging potion of the slider when urging the flexible printed circuit board or flexible flat cable. Therefore, when the slider is pivotally moved, the urging portions are rotated between the contact portions and fitting portions of the contacts to ensure that the flexible printed circuit board or flexible flat cable is urged against the contact portions of the contacts without any displacement of the slider in the direction opposite to the urging direction, so that no defective electrical connection occurs.

(6) According to the invention, the contacts and further contacts are alternately arranged so that connection portions of the further contacts extend in directions opposite to the extending directions of the connection portions of the contacts, whereby an arrangement of the contacts with extremely narrow pitches can be accomplished.

(7) According to the invention, the block is provided with projections to be fitted in corresponding fitting grooves formed in the slider, thereby urging the flexible printed circuit board or flexible flat cable against the contact portions of the contacts with certainty without any defective electrical connection.

The invention will be more fully understood by referring to the following detailed specification and claims taken in connection with the appended drawings.

### BRIEF DESCRIPTION OF THE DRAWING

FIG. 1A is a perspective view of the connector with its slider opened according to the first embodiment of the invention;

FIG. 1B is a perspective view of the connector shown in FIG. 1A with its slider closed;

FIG. 2A is a sectional view of the connector shown in FIG. 1A with its slider opened;

FIG. 2B is a sectional view of the connector shown in FIG. 1B with the slider closed;

FIG. 3A is a perspective view of the connector with its slider opened according to the second embodiment of the invention;

FIG. 3B is a perspective view of the connector shown in FIG. 3A with its slider closed.

FIG. 4A is a sectional view of the connector shown in FIG. 3A with the slider opened;

FIG. 4B is a sectional view of the connector shown in FIG. 3B with the slider closed;

FIG. 5A is a perspective view of the connector according to another embodiment of the invention;

FIG. 5B is a perspective view of the connector according to a further embodiment of the invention;

FIG. 6A is a perspective view of the connector with its slider opened of the prior art;

FIG. 6B is a perspective view of the connector of the prior art shown in FIG. 6A with its slider closed;

FIG. 7A is a sectional view of the connector shown in FIG. 6A with the slider opened;

FIG. 7B is a sectional view of the connector shown in FIG. 6B with the slider closed;

FIG. 8A is an explanatory perspective view of the connector of the prior art for explaining its problems to be solved; and

FIG. 8B is a sectional view of the connector shown in FIG. 8A with the slider closed.

### DESCRIPTION OF THE PREFERRED EMBODIMENTS

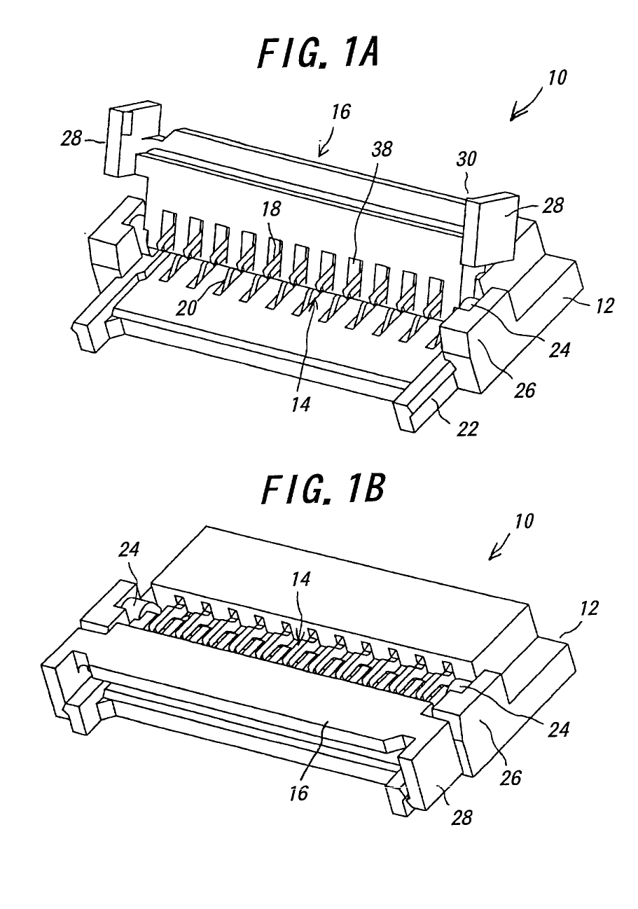

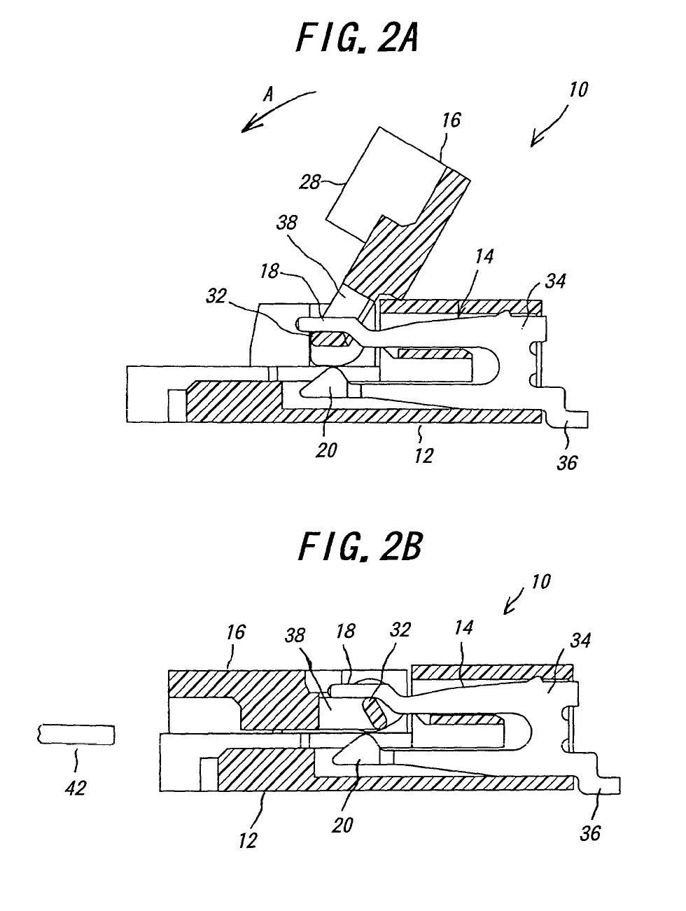

Referring first to FIGS. 1 and 2 the connector according to the first embodiment of the invention will be explained. The connector according to the invention mainly comprises a block, a slider and contacts. The slider 16 will be first described which is a subject matter of the invention.

The slider 16 is injection molded, which is the known technique, from an electrically insulating plastic material which is suitably selected in consideration of the dimensional stability, workability and manufacturing cost. Preferred materials from which to form the slider 16 of the present invention include polybutylene terephthalate (PBT), polyamide (66PA and 46 PA), liquid crystal polymer (LCP), polycarbonate (PC) and synthetic substances of these materials.

The slider 16 comprises shaft portions 24 pivotally connected to the block 12 and urging portions 32 causing a flexible printed circuit board (FPC 42) or flexible flat cable (FFC) to urge against contact portions 20 of contacts 14. The shaft portions 24 of the slider 16 are mounted in ends of the block 12 in its longitudinal directions to serve as a pivot permitting the slider 16 to move pivotally relative to the block 12.

The slider 16 is further provided at the longitudinal ends with locking portions 28 adapted to engage the block 12 for preventing the slider 16 from being raised in the direction of its height (toward the upper portion of the drawing, FIG. 1A) when urging the flexible printed circuit board (FPC 42) or flexible flat cable (FFC) against the contacts 14. The locking portions 28 need only have a shape and size such that they can engage the block 12 and are suitably designed in consideration of their function and the strength and size of the connector.

The urging portions 32 urging the flexible printed circuit board (FPC 42) or flexible flat cable (FFC) against the contact portions 20 of the contacts 14 have an elliptical cross-section in the illustrated embodiment of the invention. With this cross-section, when the slider 16 is pivotally moved in the direction shown by “A” in FIG. 2A to rotate the urging portions 32 between the contact portions 20 and fitting portions 18 of the contacts 14, the circuit board (FPC 42) or flat cable (FFC) is urged against the contact portions 20 of the contacts 14 with the aid of the particular cross-section, or elliptical cross-section of the urging portions 32. The cross-section of the urging portions 32 may have any shape so long as the portions 32 can be rotated between the contact portions 20 and the fitting portions 18 of the contacts 14 and have variable or inconstant radius of rotation in cross-section such as major and minor axes of an elliptical cross-section for urging the FPC 42 or FFC against the contacts 14.

Moreover, the slider 16 is formed with a plurality of receiving grooves 38 for receiving the fitting portions 18 of the contacts 16 when the slider 16 is urging the flexible printed circuit board (FPC 42) or flexible flat cable (FFC) against the contacts 14, in order to prevent the slider 16 from moving away from the contacts 14. The shape and size of the receiving grooves 38 may be freely designed to receive the fitting portions 18 of the contacts 14 in consideration of the size and strength of the connector 10.

Then, the contacts 14 will be explained. The contacts 14 are made of a metal by means of the known press-working. The materials from which to form the contacts 14 may be preferably brass, beryllium copper, phosphor bronze and the like which substantially comply with the imposed requirements for springiness and high conductivity.

The contact 14 is substantially in the form of a U-shape as shown in FIGS. 2A and 2B and mainly comprises a contact portion 20 to contact a flexible printed circuit board (FPC 42) or flexible flat cable (FFC), a connection portion 36 to be connected to a board, a fixed portion 34 to be fixed to the block 12, and the fitting portion 18 adapted to be received in the receiving groove 38 of the block 12. The contact portion 20 is in the form of a protrusion for facilitating bringing it into contact with the flexible printed circuit board (FPC 42) or flexible flat cable (FFC). The connection portion 36 is of the surface mounting type (SMT) in the illustrated embodiments, but it may be of a dip type.

The fitting portion 18 of the contact 14 serves to prevent the slider 16 from moving away from the flexible printed circuit board (FPC 42) or flexible flat cable (FFC) being urged against the contacts 14 and is located in opposition to the contact portion 20. The shape and size of the fitting portion 18 may be suitably designed in considering of its function and the strength and the like of the contact 16.

The block 12 will be explained hereinafter. The block 12 is injection molded, which is the known technique, from an electrically insulating plastic material which is suitably selected in consideration of the dimensional stability, workability and manufacturing cost. Preferred materials from which to form the block 12 of the present invention include polybutylene terephthalate (PBT), polyamide (66PA and 46PA), liquid crystal polymer (LCP), polycarbonate (PC) and synthetic substances of these materials.

The block 12 is formed with insertion apertures for receiving the required number of the contacts 14 which are fixed therein by press-fitting or welding. The block 12 is further provided at its longitudinal ends with bearing portions 26 for rotatably supporting the shaft portions 24 of the slider 16. The shape and size of the bearing portions 26 of the block 12 may be designed so as to rotatably support therein the shaft portions 24 of the slider 16 in consideration of the function of the bearing portions 26 and the strength and size of the block 12. Moreover, the block 12 is further provided at its longitudinal ends with anchoring portions 22 at locations corresponding to the locking portions 28 of the slider 16.

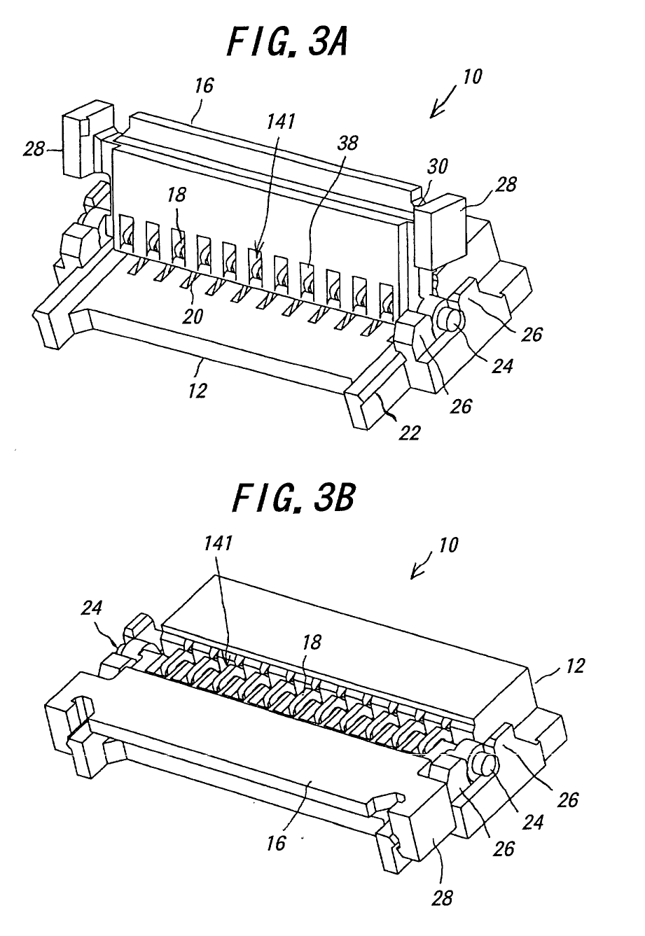

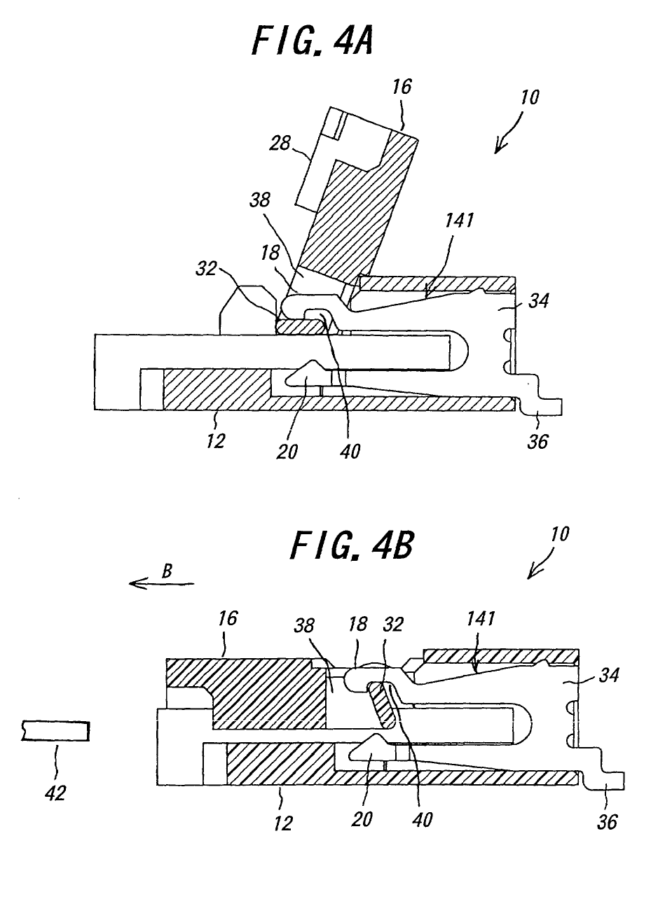

The connector according to the second embodiment of the invention will be explained hereafter referring to FIGS. 3A and 3B and 4A and 4B. As the connector of the second embodiment is substantially similar to that of the first embodiment, only different features of the second embodiment from the first embodiment will be explained. Although the bearing portions 26 of the block 12 in the second embodiment are somewhat different in shape from those in the first embodiment, the blocks in both the embodiments are similar in function to each other, so that the block 12 will not be described in further detail.

Contacts 141 of the second embodiment are different from those of the first embodiment. Likewise, the contact 141 comprises contact portion 20, a connection portion 36, a fixed portion 34, and a fitting portion 18. Different from the contact of the first embodiment, the fitting portion 18 is provided with a recess 40. When the slider 16 has been pivotally rotated to urge the flexible printed circuit board (FPC 42) or flexible flat cable (FFC) against the contacts 141, the urging portions 32 of the slider 16 engage the recesses 40 of the contacts 141 ensuring that the slider 16 is prevented from moving in the direction shown by an arrow “B” in FIG. 4B. The shape and size of the recesses 40 may be suitably designed to cause the urging portions 32 of the slider 16 to engage the recesses 40 and in consideration of its function and the strength of the contacts.

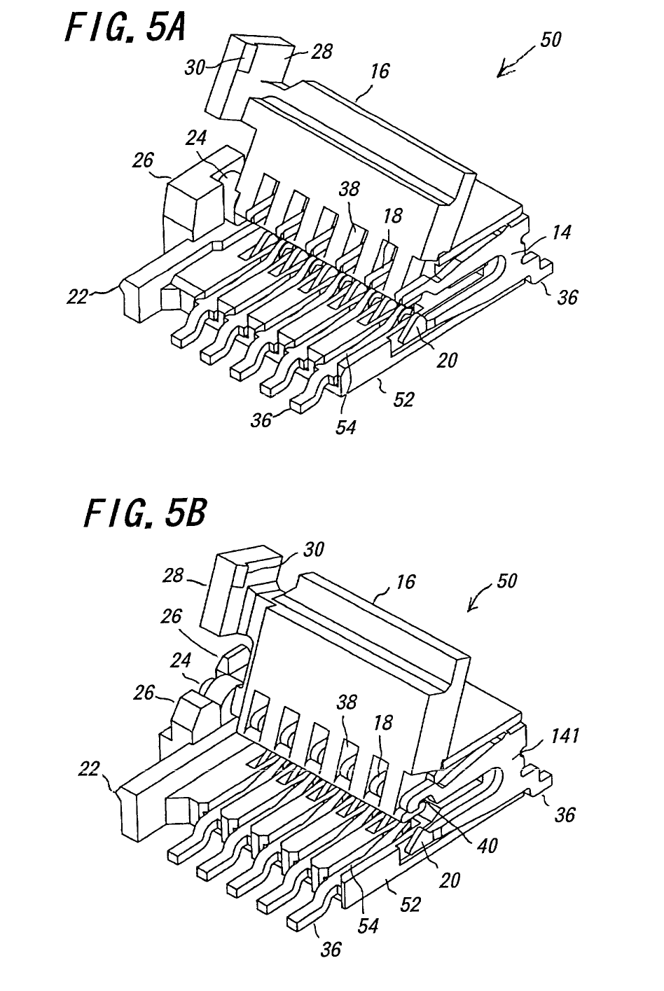

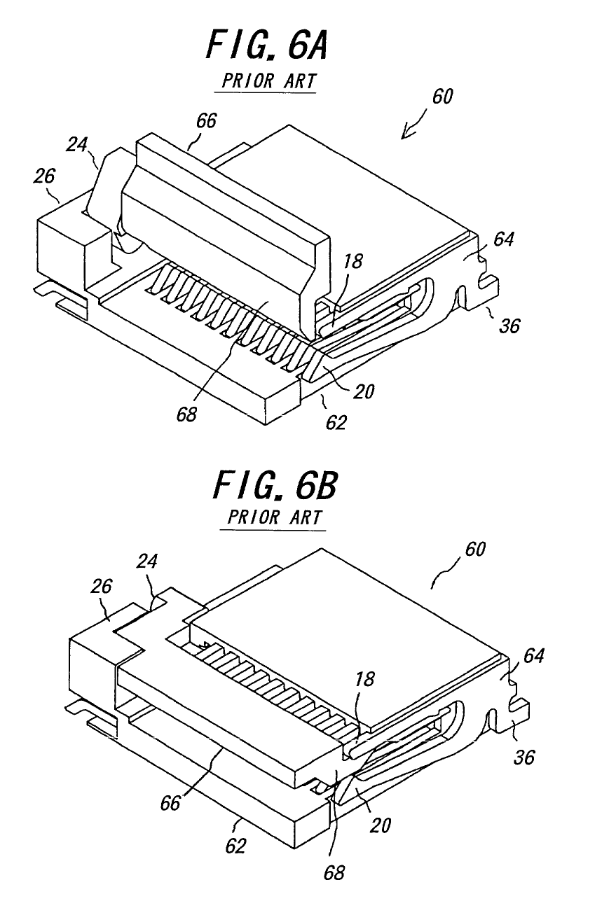

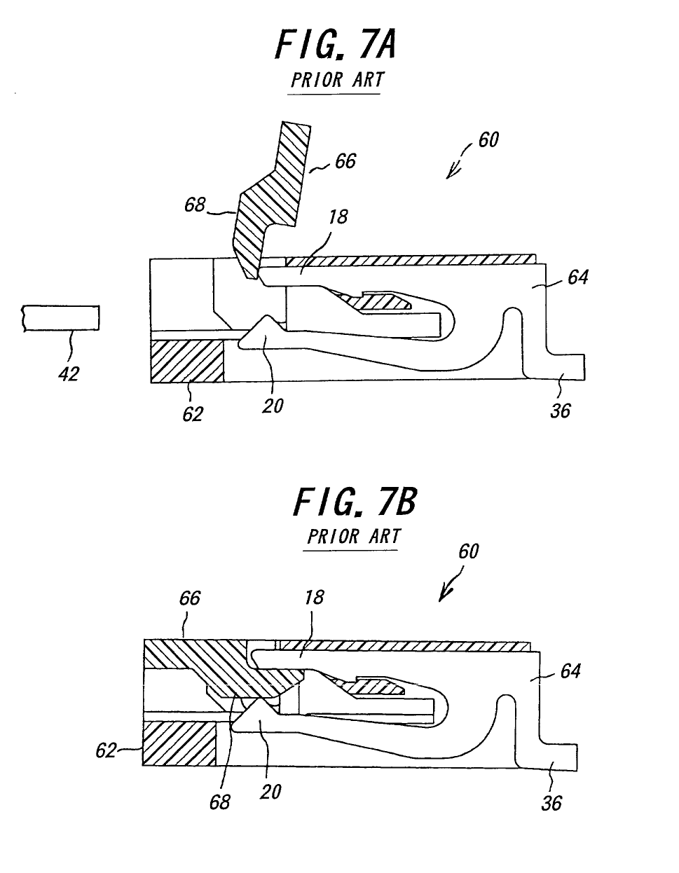

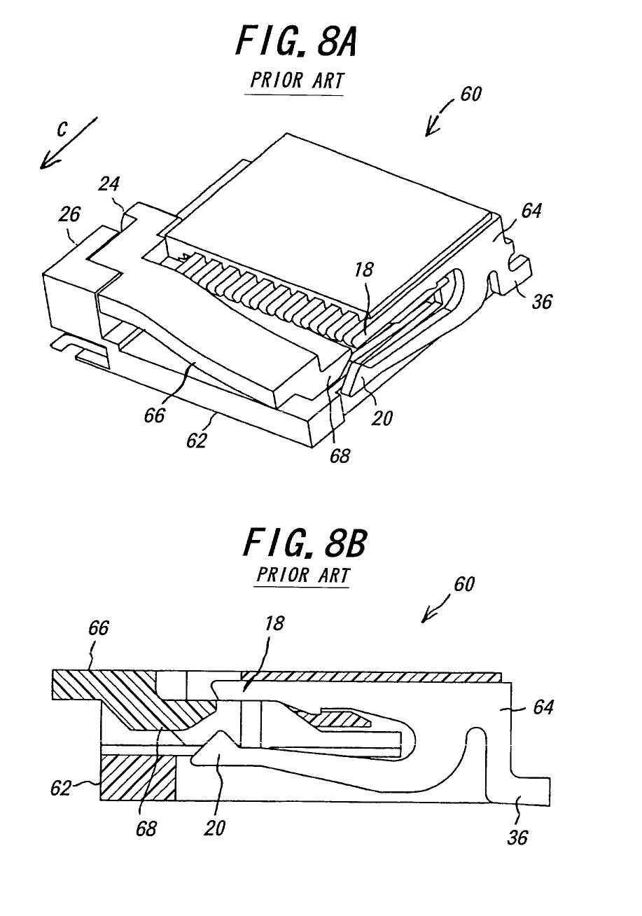

Referring to FIGS. 5A and 5B, connectors according to the third and fourth embodiments of the invention will be explained. Differences from those of the first embodiment only will be explained hereinafter.

In the third embodiment shown in FIG. 5A, contacts 54 and contacts 14 similar to those of the first embodiment are alternately arranged. In other words, the contacts 54 are arranged between the contacts 14, and connection portions 36 of the contacts 54 extend in directions opposite to the extending directions of the connection portions 36 of the contacts 14.

In the fourth embodiment shown in FIG. 5B, contacts 54 and contacts 141 having recesses 40 similar to those of the second embodiment are alternately arranged. That is to say, the contacts 54 are arranged between the contacts 141 such that connection portions 36 of the contacts 54 extend in directions opposite to the extending directions of the connection portions 36 of the contacts 14 1.

While the fitting portions of the contacts are adapted to be fitted in grooves of the slider in order to prevent the slider from moving away from the flexible printed circuit board (FPC) or flexible flat cable (FFC) when the slider is urging the board or cable against the contacts in the above four embodiments, it will be apparent that any other features for preventing the slider from moving away from the board or cable may be employed. For example, the block may be provided with projections adapted to be fitted in fitting grooves formed in the slider for preventing the slider from moving when urging the board or cable against the contacts. A pair other than the connector, (for example, a housing) may be so constructed that the urging portions 32 are prevented from moving away from the board or cable.

While the invention has been particularly shown and described with reference to preferred embodiments thereof, it will be understood by those skilled in the art that the foregoing and other changes in form and details can be made therein without departing from the spirit and scope of the invention.

What is claimed is:

1. A connector detachably fitted with a flexible printed circuit board or flexible flat cable, said connector including contacts each having a contact portion to be brought into contact with said flexible printed circuit board or flexible flat cable, a block for holding and fixing said contacts therein, and a slider mounted on said block to be pivotally movable relative therein, wherein said slider is provided with urging portions for urging on being pivotally moved the flexible printed circuit board or flexible flat cable, and said block or contacts are constructed so as to restrain said urging portions of the slider when the slider is urging the flexible printed circuit board or flexible flat cable, from moving in a direction opposite to the urging direction.

2. The connector as set forth in claim 1, wherein said slider is provided with fitting grooves in the proximity of said urging portions of the slider, and said contacts are each in the form of a substantially U-shape and provided on the side opposite to said contact portion with a fitting portion which is fitted in said fitting groove of said slider.

3. The connector as set forth in claim 1, wherein said urging portions of the slider have a cross-section whose extending distances from the center of pivotal movement of the slider in the urging direction vary before and after said pivotal movement, the extending distance after said pivotal movement being larger than before.

4. The connector as set forth in claim 3, wherein said urging portions of the slider have an elliptical cross-section.

5. The connector as set forth in claim 1, wherein said fitting portion of each of said contacts is provided with a recess which engages said urging portion of the slider when it is urging the flexible printed circuit board or flexible flat cable.

6. The connector as set forth in claim 5, wherein said contacts and further contacts are alternately arranged so that connection portions of said further contacts extend in directions opposite to the extending directions of the connection portions of said contacts.

7. The connector as set forth in claim 2, wherein said block is provided with projections to be fitted in fitting grooves formed in said slider.
